(19) United States
(12) Patent Application Publication
(10) Pub. No.: US 2003/0125954 A1
(43) Pub. Date: Jul. 3, 2003

(54) System and method at a conference call bridge server for identifying speakers in a conference call

(76) Inventors: James Frederick Bradley, Middletown, NJ (US); Basheer M. Tannu, Tinton Falls, NJ (US)

Correspondence Address: BROWN, RAYSMAN, MILLSTEIN, FELDER & STEINER LLP, 900 THIRD AVENUE, NEW YORK, NY, 10022, US

(21) Appl. No.: 10/314,882

(22) Filed: Dec. 9, 2002

Related U.S. Application Data
(63) Continuation of application No. 09/407,580, filed on Sep. 28, 1999.

(51) Int. Cl. G10L 21/00

(52) U.S. Cl. 704/270

(57) ABSTRACT

The invention provides a method and system for adding conference call speaker identification capabilities to a conference call bridge server. The system uses both speech recognition as well as line activity to determine which conference call participant is speaking at any given time. This speaker identification data is broadcast to all conference call participants in various formats, such as in the form of audio, text, and multimedia messages. This allows different types of terminal devices to receive and process the speaker identification data and present it to the participants.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates to conference calling telephony products and services. More particularly, the invention relates to a real-time speaker identification during a multiparty conference call using circuit switched or packet telephony.

Telecommunication conference calling services are commonly used by business customers to conduct meetings across several geographically diverse locations. By calling a conference bridge number and entering either the host code or a conference code, all of the conference callers are bridged onto the conference call. Using this service, geographically dispersed users can conduct business using the telephone network.

Traditional conference calling services are implemented using a conference bridge switch/server in conjunction with the public switched telephone network (PSTN). The network architecture of an existing conference calling system is shown in FIG. 1. Typically, the conference bridge server 10 is accessed by users 12 by calling a toll-free number. Each conference call on the bridge is identified by a host code and a conference code, which are preassigned when the conference call is reserved. This configuration supports global conference calling via the PSTN 14 using terminal devices native to each user's local network. Thus, users 12 may call from a variety of telephone terminal devices including analog phones, digital phones such as DTMF or ISDN, wireless phones or pay phones. Users 12 may also call from a personal computer having an ISDN card and operating Voice over IP or telephony software such as NETMEETING software available from Microsoft Corp. or PROSHARE software available from Intel. Users on a PC LAN may access the call by going through an appropriate IP/PSTN telephony gateway.

Each user calls the conference bridge, and a circuit from each user is bridged at the conference bridge 10 allowing every user to talk or listen simultaneously with other users. Most conference bridges perform some speech/call processing to improve the voice quality on the conference call. For example, one common bridge feature is to transmit only the current or last two active speaker lines. This effectively puts the listener's transmit side on mute and reduces the noise on the call. The bridge 10 uses a digital signal processor (DSP) based speech activity detector to determine line activity. Echo cancellation processing at the bridge 10 may also be provided to prevent multipath echo transmission from the conference bridge 10.

A difficulty with voice conferencing is that speakers at remote sites are often unknown to at least some of the conference callers. This results in the frequent need for callers to ask speakers to identify themselves as they speak. When videoconferencing technology is used by all callers, such as through a PC running telephony software as described above, this problem is circumvented to some degree by the display of video images of the callers, including the speaker. However, current conference call systems allow for many types of terminal devices, as explained above.

The problem of identifying conference call speakers was also partially addressed in U.S. Pat. No. 5,450,481, issued Sep. 12, 1995. As described in this patent, each telephone is equipped with a special conference tracker device which transmits tracking signals to other such tracker devices attached to other phones. The tracking signals are special audio pulses which may identify the identity and location of the party presently speaking. Of course, this system is effective only so long and for those users who actually have the special device installed and operating. Many users in any given conference call are likely not to have such a device installed on their telephones. In addition, callers participating through other telephone terminals such as wireless phones, pay phones, or PCs would not be able to participate in the tracking system.

There is thus a need for improved conference call tracking technology which facilitates the identification of speakers on a conference call bridging callers using a variety of different terminal devices.

### SUMMARY OF THE INVENTION

The present invention solves this need through a conference call speaker identification system and method. The conference call speaker identification system is installed as part of the conference call bridge server to provide for centralized speaker identification and eliminate the need for extra devices to be provided at the participant's telephones or other terminals. The system is connectable to a variety of terminal devices through the PSTN, the Internet, or other communication network. The system registers new conference call participants through a speech recognition system, such as by training the speech recognition system through a dialog with the participant or retrieving previously stored speech data for the participant. This speech recognition data is used in conjunction with line activity monitoring to determine the identity of any speaker in a given conference call.

The speaker's identity is transmitted to the other conference call participants such as through broadcasting of an audio or data message over the telephone link. The speaker's identity is displayed as a text message on a display phone or as an image on a multimedia terminal such as a PC connected to the conference call. Supplemental services such as highlighted speaker image broadcast may also be provided by the system. The system or the terminal devices may store speaker identification data in a stack so as to allow for scrolling back to identify previous speakers.

For any participant using a telephone without video capabilities, an image may be stored in a database accessible to the system and may be retrieved when the participant is speaking. The image data as well as animation applet may be transmitted to the other terminals to show a simulated image of the participant speaking.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing prior art conference bridge network architecture;

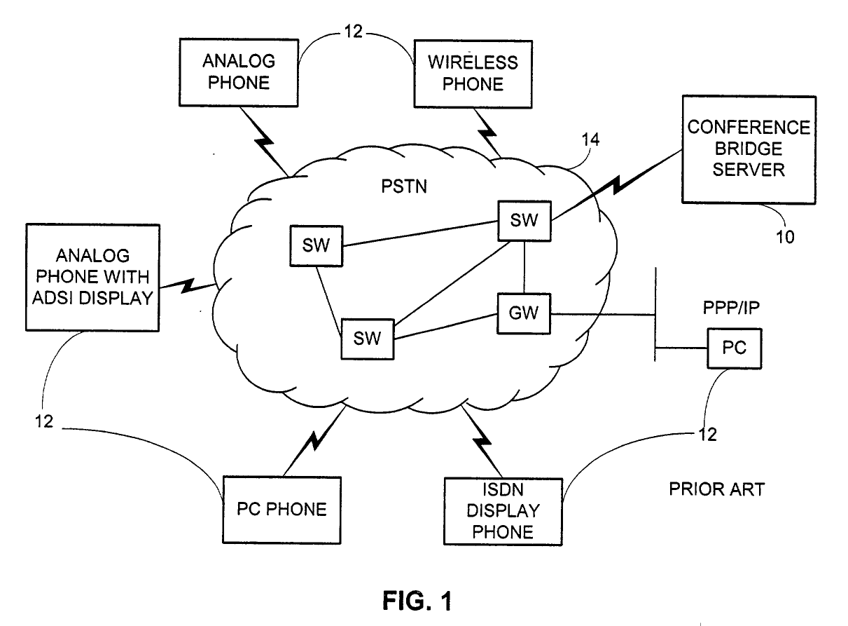

FIG. 2 is a block diagram showing an improved conference bridge network including a conference call speaker identification system in accordance with the present invention;

FIG. 3 is a block diagram showing functional elements of the conference call speaker identification system of one embodiment of the present invention;

FIG. 4 is a flow chart showing a process of identifying conference call participants in accordance with one embodiment of the present invention; and

FIG. 5 is a flow chart showing in greater detail a process of registering conference call participants in accordance with one embodiment of the present invention;

FIG. 6 is a flow chart showing a process of determining which conference call participant is speaking in accordance with one embodiment of the present invention; and

FIG. 7 is a block diagram showing a conference call speaker identification system which communicates with devices over the PSTN and the Internet in accordance with the present invention.

### DETAILED DESCRIPTION OF THE PREFERRED EMBODIMENTS

Preferred embodiments of the present invention are now described in detail with reference to the drawings in the figures.

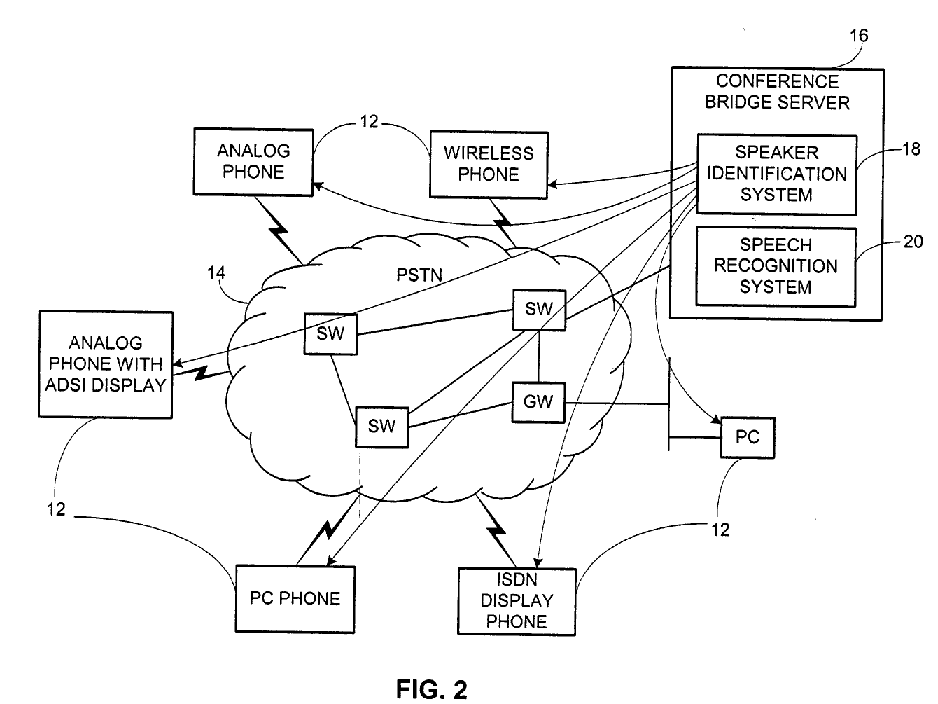

As shown in FIG. 2, an improved conference call bridge server 16 is provided which is connected to various telephone terminals representing conference call participants 12 through the PSTN 14. The telephone terminals may be using any of the standard circuit switched transport and signaling protocols including ISDN BRI, ISDN PRI, or in-band channel associated signaling (CAS). Transport and signaling connections are made using the standard PSTN protocols.

The conference call bridge server 16 includes a speaker identification system 18 and a speech recognition system 20. As described in greater detail below, the speaker identification system 18 registers conference call participants 12 using the speech recognition system 20 and determines which participant is speaking at any given time. Data identifying the speaker is then broadcast to the conference call participants 12 through the PSTN, and the telephone terminal devices used by participants 12 present this data in a manner dependent upon the capabilities of the telephone terminal device used.

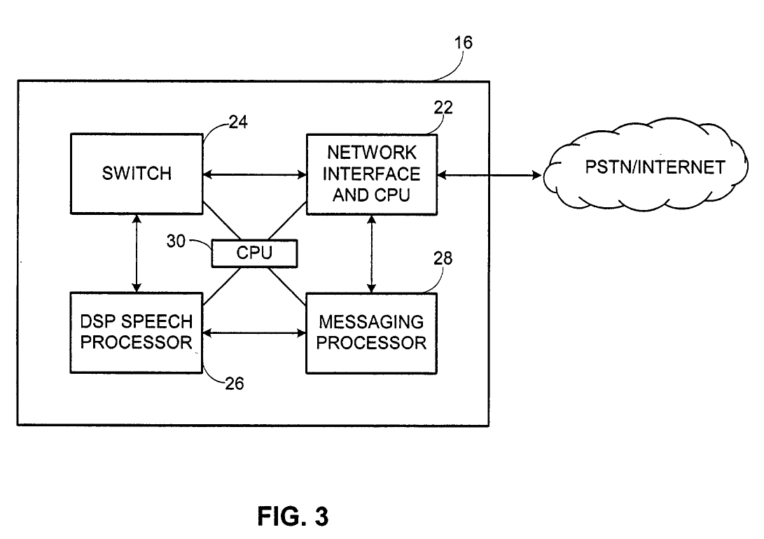

The conference call bridge and speaker identification system 16 is shown in functional form in FIG. 3. A network interface or ISDN processor 22 terminates the transmission layer protocol and extracts transport and signaling data from the circuit or IP application flow. The network interface 22 is coupled to a conference switch 24, which has conventional circuit bridging functionality. The switch 24 provides a point-to-multipoint broadcast of the active speaker's circuit or packet flow. A digital speech processor 26 coupled to the switch 24 performs line activity monitoring and detection and speaker identification by training on the participant's voice, as explained further herein. A message processor 28 is used to process display requests and broadcast speaker identification to the conference user terminals. The message processor 28 further supports enhanced services. A CPU 30 provides server control and processing capabilities.

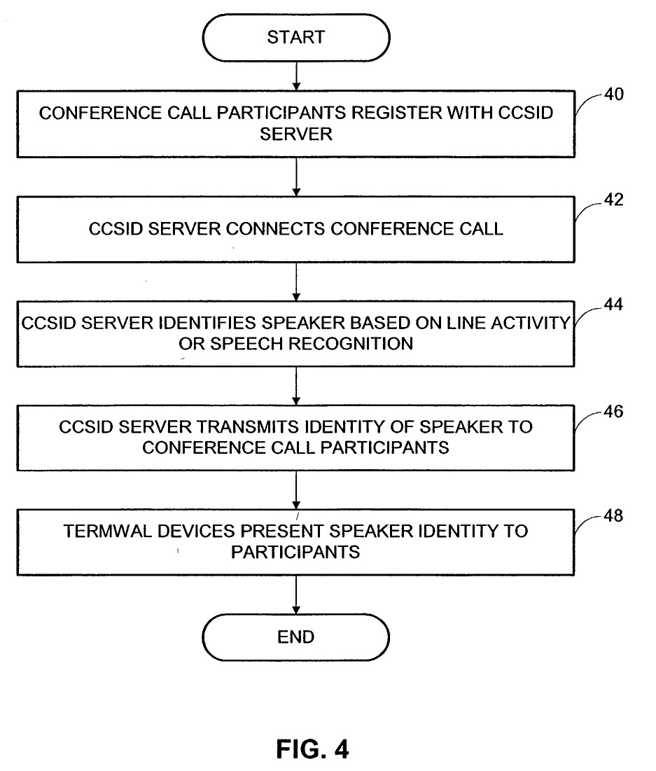

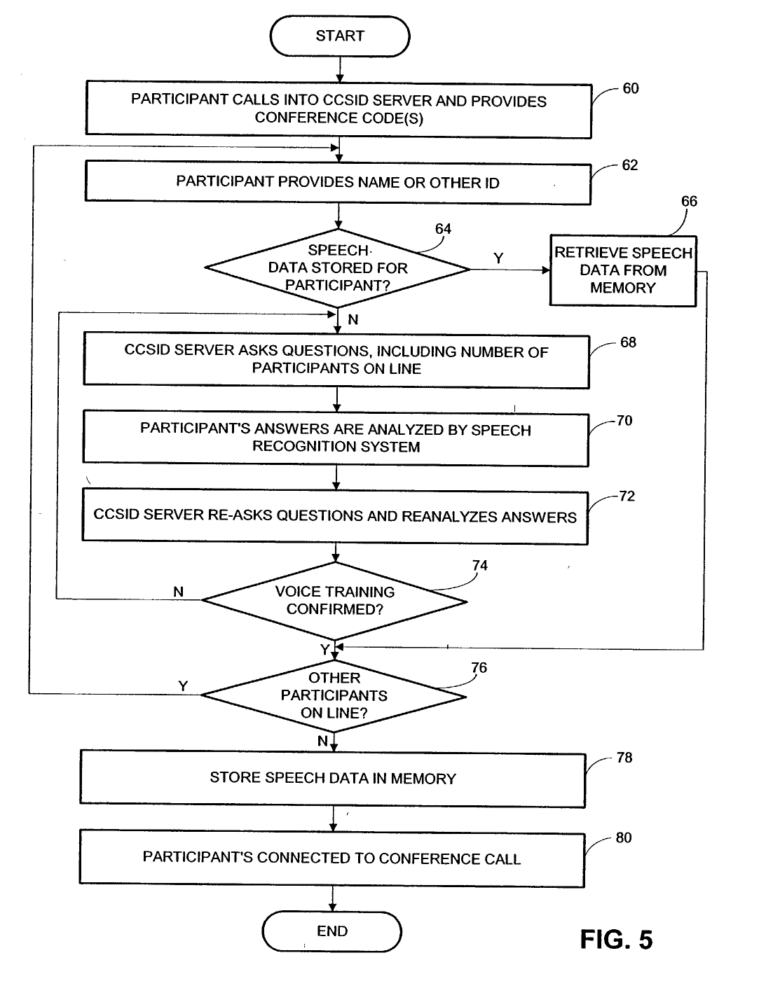

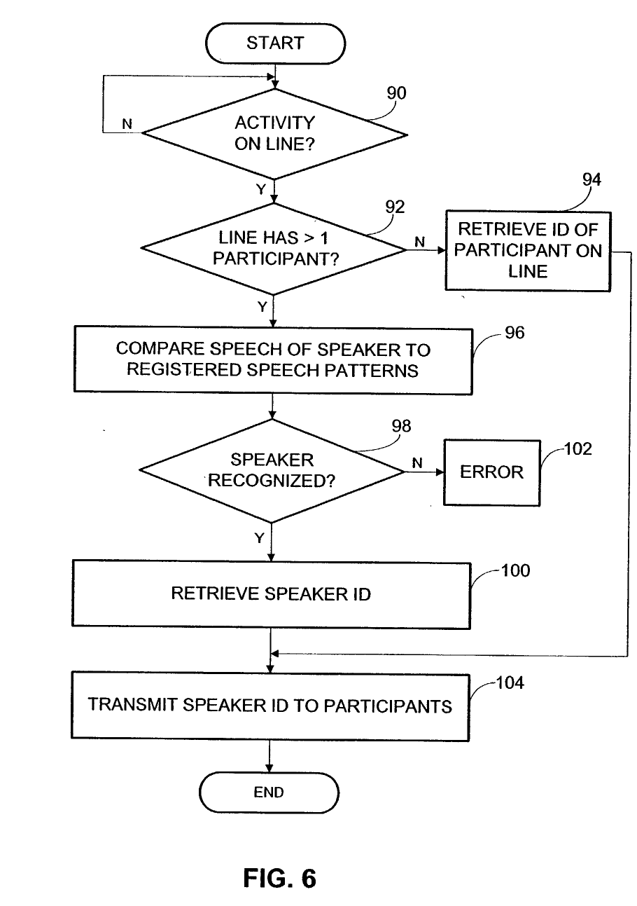

The process performed by the conference call speaker identification system in accordance with one embodiment of the invention is shown in FIG. 4. To initiate a conference call, the participants register with the conference call speaker ID system and bridge server, step 40. The registration process of one embodiment is described in greater detail below with reference to FIG. 5. The conference call server then connects the participants into a conference call, step 42. During the conference call, the conference call server monitors the audio signals and identifies the speaker based on the presence of line activity and/or a speech recognition analysis performed on the speaker's voice, step 44. The speaker identification process of one embodiment is described in greater detail below with reference to FIG. 6. Once the speaker is identified, the conference call server transmits data identifying the speaker to the conference call participants, step 46. The telephones or other terminal devices used by the participants receive the speaker identification data and present it to the participants, step 48. The process of identifying speakers and broadcasting the identity data continues until the end of the conference call.

Referring now to FIG. 5, conference call participants register with the conference call server by calling into the conference call server, such as through a toll-free number, and providing conference codes such as a host code, name or password, step 60. At this point, the participant's phone has been connected to the bridge via the PSTN with a switched circuit. The participant provides a name or other identifying data which will be used to identify the participant to thew other participants, step 62. Alternatively, this name or data may be provided in advance, when the conference call is ordered by the host.

In some embodiments, the conference call server stores speech data for participants as they register, and this speech data may be used when the participant gets involved in another conference call. Thus, the server checks whether speech data is stored for this participant, step 64, and, if so, retrieves the previously generated and stored speech data from memory, step 66. If no speech data is stored for this participant, the conference call server asks the participant a series of questions through a voice message system, such as name, location, weather, etc., and also asks whether other participants are sharing the line, step 68. The participant's responses are analyzed by the speech recognition system to thereby train the speech processor to recognize his voice and determine his name, step 70. To provide for better training, the conference call server repeats the sequence of questions and responses, step 72.

If the conference call server achieves a sufficient level of confidence in its ability to recognize the participant, the voice training is confirmed, step 74. Otherwise, the process of training through questions and responses is repeated until training is confirmed. This results in creation of a voice print image of the participant. If there are other participants on the same line, step 76, the registration process is repeated for each additional participant. When completed, in accordance with some embodiments the voice print images are stored in a nonvolatile memory accessible to the conference call server, step 78, for use in later conference calls. The conference call server then connects or bridges the participants into the conference call, step 80.

Referring now to FIG. 6, during the conference call the conference call server monitors the lines to determine which line or lines are active at any given time, step 90. In some packet telephony systems, the conference call server is not the only network element which determines line activity. In packet telephony systems using silence activity detection (SAD), the transmitting terminal determines periods of silence and suppresses any packet transmission during intervals of silence. Therefore, the conference call server will have no activity on that line during periods of silence.

In some embodiments, the conference call server determines whether an active line has more than one participant registered, step 92, such as through the use of a speakerphone or PBX conference feature calling off-net. If only one participant is registered, the identification data for that participant is retrieved, step 94. In alternative embodiments, the conference call server performs a voice recognition analysis on all speakers, even when only one participant is registered on an active line, in order to reinforce the accuracy of the identification process and reduce the likelihood of error. If an active line has more than one participant, the speaker's speech is compared with the voice print images registered for the active line, step 96.

If the speaker's voice is recognized, step 98, the speaker identification data is retrieved, step 100. If the speaker's voice fails to match the stored voice print images for participants on the active line, an error message is generated, step 102, such as “speaker not recognized.” The conference call server may then request that the unrecognized speaker be registered and trained in accordance with the process described above.

Once speaker identification has been retrieved, or an error message generated, this data is transmitted to the participants, step 104. The message processor (28 in FIG. 3) broadcasts the speaker identification data, such as first name and first letter of last name, using the D channel or CAS channel, as appropriate, for each of the bridged lines or circuits. If a participant has an analog phone enabled with an analog display services interface (ADSI) display device, that participant will receive and display the speaker's identification.

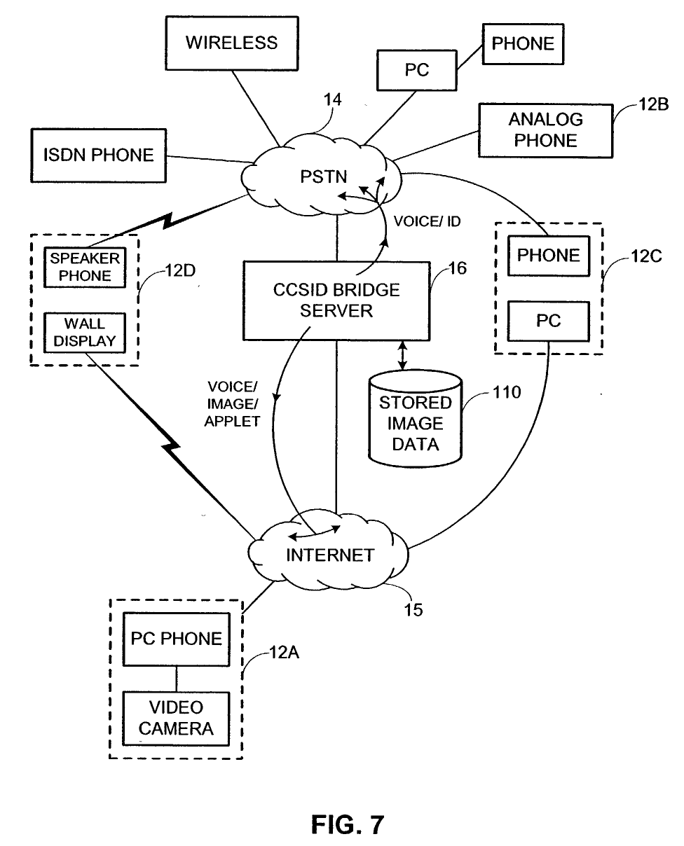

FIG. 7 shows a conference call server identification architecture for Internet telephony conference services. The CCSID server 16 in this network architecture bridges callers calling through the PSTN 14 as well as the Internet 15. Participants may be using a variety of terminal devices, including a multimedia PC with audio and video capabilities 12A connected through the Internet and a conventional telephone 12B connected through the PSTN. Hybrid configurations are also used, including a hybrid terminal configuration 12C of phone and PC, with the phone connected through the PSTN and the PC through the Internet, and a hybrid workgroup configuration 12D having a speakerphone connected through the PSTN and a wall display unit for the video image display connected through the Internet.

The parties dial into the CCSID server 16 with their terminals. Using the process described above, the regular phone user 12B dials the bridge number, enters the access code and trains the speech processor in the CCSID 16. The Internet devices such as PC phone 12A access the CCSID server by going to a designated IP address ad registering as a conference call participant, using the same password as telephone participants. The Internet participants train the speech processor using their audio capabilities connected over the Internet connection with the CCSID server 16. The users with hybrid configurations, such as users 12C and 12D, access the CCSID server 16 using both methods—an IP connection for the image and video data and a separate circuit connection via the PSTN for voice.

In FIG. 7, participants using the phone 12B do not have video connection with the conference call server 16. Image data of the participants using the phone 12B, provided in advance, are stored in an image database 110 accessible to the conference call server 16. Since the image data is stored, it is not a real-time image like the images of speakers using video recording capabilities. However, in some embodiments the image data of the participants using phone B are personalized through animation or color enhancement to more realistically represent the participants to the other participants using video display devices, including participants 12C and 12D. When the participant without video recording capabilities is identified as the speaker, the conference call server retrieves the image data of the speaker from the image database 110 and transmits the image data along with an applet, using JAVA or ActiveX technology, to the participants connected over the Internet. The applet, which may also be previously provided by the participant using the phone, animates the image data on the participants' displays to simulate body and hand motions in a realistic fashion. The applet will function on all properly enabled devices, including PCs, web phones, palm top devices, etc.

At the hybrid terminal configurations 12C and 12D, the conference participants use the phone for audio and the PC, wall display or other display device to display the images. As an option, the hybrid terminal participant may register with the conference call server 16 using the PC, and the conference call server would then call the participant on the associated phone. Participants having a video camera record video images of the speaker on a real-time and transmit compressed video data to the conference call server 16, which then retransmits the video data to all conference call participants using the Internet.

In this configuration, the conference call server 16 acts as a PSTN/Internet gateway and it provides a protocol conversion for audio from PSTN PCM coded voice to packet IP or ATM voice. The signaling channel is also converted. In addition, the conference call server 16 splits the audio and video data based upon the end terminal capabilities. These functions of the conference call server may be implemented using the Softswitch platform available from Lucent Technologies.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for identifying speakers involved in a conference call, the conference call being coordinated by a conference bridge server, the method comprising:
registering conference call participant identities at the conference bridge server using a speech recognition system;
the conference bridge server determining the identity of a conference call participant who is speaking; and
the conference bridge server transmitting the identity of the conference call speaker to conference call participants.

2. The method of claim 1, wherein the step of determining the identity of the conference call speaker comprises determining which line of a plurality of lines involved in the conference call is active.

3. The method of claim 2, wherein the step of determining the identity of the conference call speaker further comprises performing speech recognition analysis on the conference call speaker and determining the identity of the speaker based at least in part upon the registered conference call participant identities.

4. The method of claim 3, wherein the step of performing speech recognition analysis on the conference call speaker is performed on the line determined to be active.

5. The method of claim 2, wherein the step of determining the identity of the conference call speaker further comprises performing speech recognizing analysis on the conference call speaker only if more than one participant is registered on the line determined to be active, and determining the identity of the speaker based at least in part upon the registered conference call participant identities.

6. The method of claim 1, wherein the step of registering conference call participant identities comprises training the speech recognition system for each participant who calls into the conference bridge server to participate in the conference call.

7. The method of claim 1, wherein the step of registering conference call participant identities comprises storing in a database accessible to the conference bridge server speech recognition data records, and querying the database to retrieve speech recognition data records if available for each participant who calls into the conference bridge server to participate in the conference call.

8. The method of claim 1, wherein the step of transmitting the identity of the conference call speaker comprises the conference bridge server broadcasting an audio message containing the conference call speaker identity to the conference call participants.

9. The method of claim 1, wherein the step of transmitting the identity of the conference call speaker comprises the conference bridge server broadcasting a data message containing the conference call speaker identity to the conference call participants, the data message having a format capable of being interpreted by participants connected to the conference call by public switched telephone network and by the Internet.

10. The method of claim 1, comprising the conference bridge server storing image data representing a conference call participant, and wherein the step of transmitting the identity of the conference call speaker comprises the conference bridge server retrieving image data representing the conference call speaker if stored and transmitting the image data to one or more conference call participants.

11. The method of claim 10, comprising animating the image data of the conference call speaker to thereby simulate an image of the conference call speaker speaking.

12. The method of claim 11, wherein the step of animating the image data comprises the conference bridge server transmitting an applet containing code for animating the image data.

13. A computer readable medium storing program code for, when executed, causing a conference bridge server to perform a method for identifying speakers involved in a conference call coordinated by the conference bridge server, the method comprising:
registering conference call participant identities using a speech recognition system;
determining the identity of a conference call participant who is speaking; and
transmitting the identity of the conference call speaker to conference call participants.

14. A conference call bridge server system comprising:
means for registering conference call participant identities using a speech recognition system;
means for determining the identity of a conference call participant who is speaking; and
means for transmitting the identity of the conference call speaker to conference call participants.

15. A conference call system comprising:
a conference bridge server capable of coordinating a conference call, recognizing through a speech recognition system identities of conference call participants who are speaking, and transmitting conference call speaker identity data to conference call participants through a public switched telephone network and the Internet;
one or more terminal devices connected to the conference bridge server through the public switch telephone network; and
one or more terminal devices connected to the conference bridge server through the Internet.
